(19) United States
(12) Patent Application Publication
(10) Pub. No.: US 2019/0311746 A1
(43) Pub. Date: Oct. 10, 2019

(54) Indexing media content library using audio track fingerprinting

(71) Applicant: Deluxe One LLC, Burbank, CA (US)

(72) Inventor: Andrew Shenkler, Playa Vista, CA (US)

(21) Appl. No.: 16/378,539

(22) Filed: Apr. 8, 2019

Related U.S. Application Data
(60) Provisional application No. 62/654,265, filed on Apr. 6, 2018.

(51) Int. Cl. G11B 27/32; G10L 19/018; G06F 16/71; G06F 16/783

(52) U.S. Cl. CPC G11B 27/32; G06F 16/7834; G06F 16/71; G10L 19/018

(57) ABSTRACT

A computer-implemented video classification system includes a storage device configured to ingest and store video files having respective audio tracks. Processors in the system are configured with instructions to perform a perceptual hash algorithm on each of the audio tracks to generate one or more audio fingerprints for each audio track. The audio fingerprints are associated with the respective video files. The video files are indexed based upon the audio fingerprints. Audio tracks from unknown video files are hashed and compared to audio fingerprints of known video files in a repository to identify the unknown video files.

### CROSS REFERENCE TO RELATED APPLICATIONS

This application claims the benefit of priority pursuant to 35 U.S.C. § 119(e) of U.S. Provisional Application No. 62/654,265 filed 6 Apr. 2018 and entitled “Indexing media content library using audio track fingerprinting,” which is hereby incorporated herein by reference in its entirety.

### TECHNICAL FIELD

The technology described herein relates to indexing video-based media content using audio fingerprinting.

### BACKGROUND

Companies working in media services may receive content from hundreds of sources. For example, content creators, broadcasters, and distributors may receive content from film studios, music production companies, and the like. In order to properly manage this large influx of content, such companies often organize media into categories, such as origin, type, genre, title, and version.

Often, documentation or file names are the first piece of information reviewed to organize media files in a media library or database. However, these pieces of information are often incorrect or incomplete. Thus, for better accuracy, the media file must be opened in order to identify its content. For example, current processes for indexing film in media libraries require viewing the film to determine its title. Further, there may be several different versions of the film that need individual identification so that they can be indexed as unique media files for easy retrieval. For example, there may be a master version, a director's cut, an original theatrical release, a made-for-TV version, an airline version, a foreign language version, and the like. In order to determine whether a video file is a different version from the other video files in the library, the films must be compared frame by frame to detect any differences. This is a tedious and time-consuming process, especially when trying to differentiate multiple versions of the same film which are highly consistent throughout, and it is often difficult to detect slight changes with the human eye.

There is a need for an easier method of identifying and indexing content.

The information included in this Background section of the specification, including any references cited herein and any description or discussion thereof, is included for technical reference purposes only and is not to be regarded subject matter by which the scope of the invention as defined in the claims is to be bound.

### SUMMARY

In one implementation, a computer-implemented video classification system includes a storage device configured to ingest and store one or more video files thereon, wherein the one or more video files comprise one or more respective audio tracks. The system also includes one or more processors configured with instructions to perform the following steps: perform a perceptual hash algorithm on each of the one or more audio tracks; generate one or more audio fingerprints for the respective one or more audio tracks; associate the one or more audio fingerprints with the respective one or more video files; and index the one or more video files based upon the one or more respective audio fingerprints.

In another implementation, a method is implemented in a computer system for identifying video files in a media library. One or more processors in the computer system is particularly configured to perform a number of processing steps including performing an audio perceptual hash of a plurality of audio tracks associated with a plurality of video files in a media library to produce a plurality of audio fingerprints; associating each audio fingerprint with a respective video file in the media library; creating a media library of identifiable video files based upon the respective audio fingerprint; comparing the plurality of audio fingerprints to determine whether any of the plurality of audio fingerprints match within a threshold matching rate; and, if there is a match between two or more audio fingerprints within the threshold matching rate, identifying the respective video files associated with the two or more audio fingerprints as different versions of the same video file.

In a further implementation, a non-transitory computer readable storage medium contains instructions for instantiating a special purpose computer to index an unknown video file in a media library of known video files, wherein the instructions implement a computer process comprising the following steps: ingesting and storing one or more known video files on a storage device within a computer system, wherein the one or more known video files are associated with one or more hashed audio tracks with one or more associated audio fingerprints; receiving one or more unknown video files; performing audio perceptual hashing of one or more audio tracks associated with the one or more unknown video files to produce one or more associated audio fingerprints of the one or more unknown video files; comparing the one or more audio fingerprints of the one or more unknown video files to the one or more audio fingerprints of the one or more known video files; and determining a match level for each of the one or more audio fingerprints of the one or more unknown video files to each of the one or more audio fingerprints of the one or more known video files; and identifying and indexing the one or more unknown video files based upon the match level to each known video file.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and implementations and illustrated in the accompanying drawings.

### BRIEF DESCRIPTION OF THE DRAWINGS

FIG. 1 is a flow chart illustrating a method of indexing media files by audio fingerprinting.

FIG. 2 is a flow chart illustrating a method of identifying and indexing unknown media content through audio fingerprint matching.

FIG. 3 is a schematic diagram illustrating a method of fingerprinting an audio track.

FIG. 4 is a schematic diagram illustrating a method of audio fingerprint matching.

FIG. 5 is a schematic diagram illustrating an example of indexed media files in a media library based on the audio fingerprint matching of FIG. 4.

FIG. 6 is a schematic diagram of an exemplary system over a distributed network for identifying and indexing unknown media content through audio fingerprint matching.

FIG. 7A is a flow diagram depicting the steps in an exemplary implementation of fingerprinting audio of a media file using the system of FIG. 6.

FIG. 7B is a flow diagram depicting the steps in an exemplary implementation of identifying an unknown media file by comparing audio fingerprints within a media library using the system of FIG. 6.

FIGS. 8A and 8B are schematic diagrams depicting the increased processing speed of the fingerprinting and identifying processes when instantiated on the system of FIG. 6.

FIG. 9 is a schematic diagram of an exemplary computer system for processing, identifying, indexing, and labeling classes of media files as described herein.

### DETAILED DESCRIPTION

This disclosure is related to identifying and indexing media content in a media library based on associated audio tracks. In several embodiments, media content in a media library may be identified and indexed by fingerprinting each audio track or tracks associated with each media file. The associated audio track or tracks may be a discrete audio track or tracks, separate from any other associated media tracks, such as video or visual effects. Alternatively, the associated audio track or tracks may be integrated within a single media file including other associated media such as a video file with an audio track. In this embodiment, each fingerprint may be compared to other fingerprints in the media library to determine whether fingerprints match within a matching threshold, and therefore whether media files associated with the fingerprints are affiliated. If a fingerprint does not match any other fingerprint in the media library, meaning it is a unique fingerprint, then the fingerprint is associated with its respective media file and the media file is indexed according to its unique fingerprint. If a fingerprint matches other fingerprints in the media library within a matching threshold, then the respective media files are associated with one another in the indexing system. For example, if the match level is within a particular matching threshold, then the media files may be considered different versions of the same media title. As another example, if a fingerprint is identical to another fingerprint, then the associated media file is considered a copy of the media file associated with the identical fingerprint.

In one embodiment, a media file, such as film and/or video, may be identified based on its respective audio track. For the purposes of this disclosure, film and video are interchangeable. In one embodiment, a film is identified by hashing the audio track to produce a unique fingerprint, which is then associated with the film. With this unique identification process, the film does not need to be played and reviewed in order to identify it, as is the case with current film identification processes. In one example, films may have several different versions (e.g., a master version, a director's cut, an original theatrical release, a made-for-TV version, an airline version, foreign language versions, and the like), which need to be uniquely identifiable to allow for quick retrieval of the appropriate version. In this case, each version of a film may have a unique audio track. Hashing the audio track of each version may therefore result in a unique fingerprint associated with each version, such that each version is easily identifiable.

In another embodiment, films are indexed in a media library based on their respective audio tracks. In one embodiment, films are indexed by comparing fingerprints of their respective audio tracks. In this embodiment, a comparison of audio fingerprints for different video files may result in various matching levels. In one example, an audio fingerprint of a video file may not match any other audio fingerprint in a media library. For example, the audio fingerprint may have less than about a 50% match with the files in the media library. In this example, the video file associated with the unique audio fingerprint will be indexed as a new media file, distinct from the rest of the media library. In another example, an audio fingerprint of a video file may match other audio fingerprints in a media library within a percentage match threshold. If there is a particular level of matching, for example greater than about 50% but less than about 95%, the video file associated with the audio fingerprint will be indexed as a new version of the film associated with the matching audio fingerprint. For example, a match level of about 85% is a strong indication that the video file is a similar title as the match in the library, but it is likely a different version. In yet another example, an audio fingerprint of a video file may have greater than about a 95% match with another audio fingerprint in a media library. In this case, the video file associated with the audio fingerprint will be indexed as a copy of the film associated with the matching audio fingerprint.

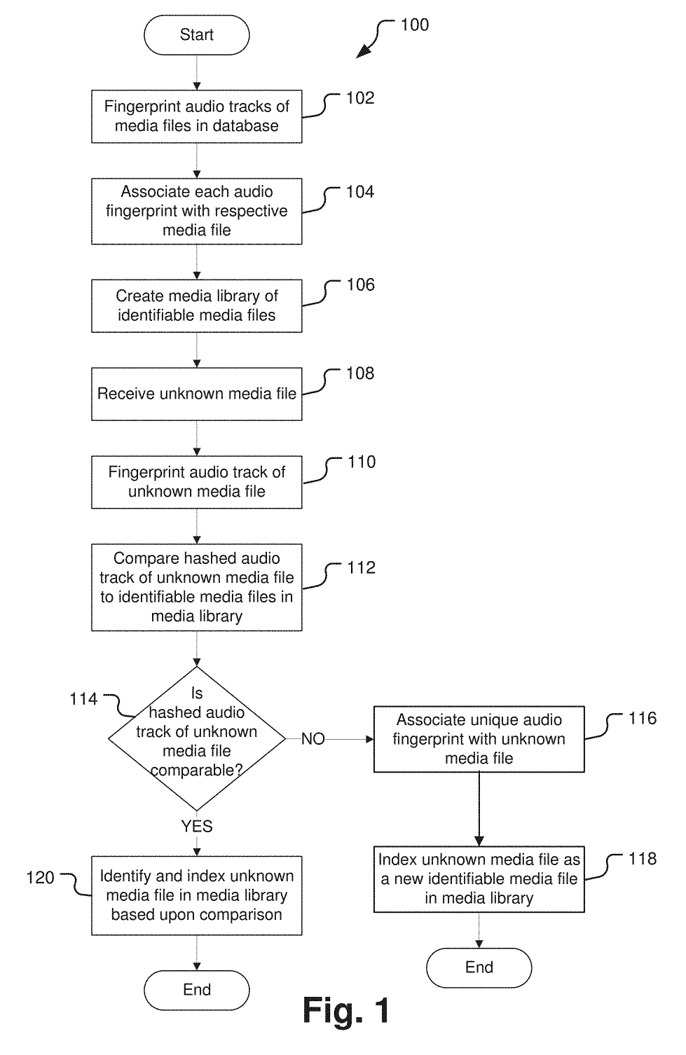

Turning now to the figures, a method of the present disclosure will be discussed in more detail. FIG. 1 is a flow chart illustrating a method of indexing media files by audio fingerprinting. The method 100 begins with perceptual hashing, or fingerprinting, of audio tracks of media files in a database at operation 102. Audio perceptual hashing may convert a long audio file into a unique and concise code, sequence, or mathematical representation based on various features of the audio signal over time, including, for example, frequency, amplitude, and waveform. The perceptual hash or fingerprint produced from the perceptual hashing process is unique to each audio file. It is contemplated that perceptual hashing, or fingerprinting, may be done by conventional methods. For example, open source perceptual hash libraries may be used, such as, for example, pHash (found at https//www.phash.org). However, the perceptual hashing of the present disclosure deviates from conventional methods in at least one respect. For example, most audio perceptual hashing methods take hashes at various sampling locations along the audio track. This is often done to avoid noise, interference, or other distortions in the signal. In the perceptual hashing method of the present disclosure, it may be desirable to perform an audio perceptual hash for the entire length of the audio signal of the media file. For example, different versions of the same media title may have slight differences at any point along their associated audio tracks. Random sampling may skip the points of variation and thus lead to an inaccurate result, e.g., the resulting perceptual hash may make it seem like the audio tracks are identical. If the system misses the differences and identifies the audio tracks as identical, it may also then incorrectly index the associated media files as copies rather than different versions. Therefore, audio perceptual hashing of the entire audio track may produce more accurate results for proper indexing of the associated media file.

After operation 102, the method 100 proceeds to operation 104 and each audio fingerprint is associated with each respective media file. For example, a film may have a unique audio track with dialogue, sound effects, and a music score. Because each audio track is unique to a particular film, a fingerprint of an audio track may become a unique identifier for the associated film. As another example, different versions of the same film may have unique audio tracks. Different cuts or edits may produce different sounds at numerous places throughout the film. For example, a made-for-television version of a film may cut out an inappropriate word or scene, thus changing the audio track of the original theatrical release version. In this example, perceptual hashing of each version of a film may result in unique fingerprints for each audio track, which creates unique identifiers for each version. In this manner, different versions of the same film can be distinguished through audio hashing.

After operation 104, the method 100 proceeds to operation 106 and a media library of identifiable media files is created. For example, a media library may be organized based on audio fingerprints for each video file. As one example, audio fingerprints may be compared and arranged in the media library based on levels of matching. For example, audio fingerprints with high degrees of matching may be categorized together in a media library. In one example, audio fingerprints with high degrees of matching may represent different versions of the same film. In this example, different versions of the same film may have similar audio tracks with only some scenes altered, deleted, or added, which may produce similar audio fingerprints with slight variations.

After operation 106, the method 100 proceeds to operation 108 and an unknown media file is received. Unknown media files may be received, for example, from various film studios, post production companies, music production companies, television networks, solo artists, or other media companies. The media file may be, for example, a feature film, a video program or segment, a television broadcast, a slide show presentation, or any other media file with an associated audio track.

After operation 108, the method 100 proceeds to operation 110 and perceptual hashing of the audio track of the unknown media file is conducted. Perceptual hashing of the audio track may be performed by the same methods previously described. Perceptual hashing of the audio track creates a fingerprint of the audio track of the unknown media.

After operation 110, the method 100 proceeds to operation 112 and the hashed audio track, or audio fingerprint, of the unknown media file is compared to the identifiable media files in the media library.

After operation 112, the method 100 proceeds to operation 114 and it is determined whether the hashed audio track of the unknown media file is comparable to any of the identifiable media files in the media library. For example, to determine similarity between audio fingerprints, a degree of matching is assessed between audio fingerprints. In one example, two audio fingerprints may be compared. In this example, the match level may be determined using an algorithm in which the hash for both audio fingerprints is compared to determine points of identical hash between the two audio fingerprints. The matching level can be calculated as a ratio of points of identical hash over the entire hash dataset. The match level is used to identify and index the media file. For example, a match level of less than about 50% may indicate no match and the associated media file is identified as a new media file and indexed accordingly. As another example, a match level within a matching threshold range of greater than about 50% to less than about 95% may indicate that the media files are associated with one another, such as, for example, different versions of the same media title, and the unknown media file may be identified as a new version of the existing media title and indexed accordingly. For example, if media files have a match level of about 85%, they may be identified and indexed as different versions of the same title. As yet another example, a match level of greater than about 95% may indicate an identical match and the associated media file may be identified as a copy and indexed accordingly.

If it is determined that the hashed audio track of the unknown media file is not comparable to any of the identifiable media files in the media library, then the method 100 proceeds to operation 116 and the unique audio fingerprint of the unknown media file becomes associated with and identifies the unknown media file. After operation 116, the method 100 proceeds to operation 118 and the unknown media file is indexed in the media library as a new identifiable media file based on its unique audio fingerprint.

If it is determined that the hashed audio track of the unknown media file is comparable to at least one of the identifiable media files in the media library, then the method 100 proceeds to operation 120 and the unknown media file is identified and indexed in the media library based upon the comparison. For example, if the match level between the hashed audio track of the unknown media file and the hashed audio track of an identifiable media file is within a matching threshold, for example between about 50% and about 95%, then the unknown media file may be identified and indexed as a new version of the identifiable media file. As another example, if the match level between the hashed audio track of the unknown media file and the hashed audio track of an identifiable media file is greater than about 95%, then the unknown media file may be identified and indexed as a copy of the identifiable media file.

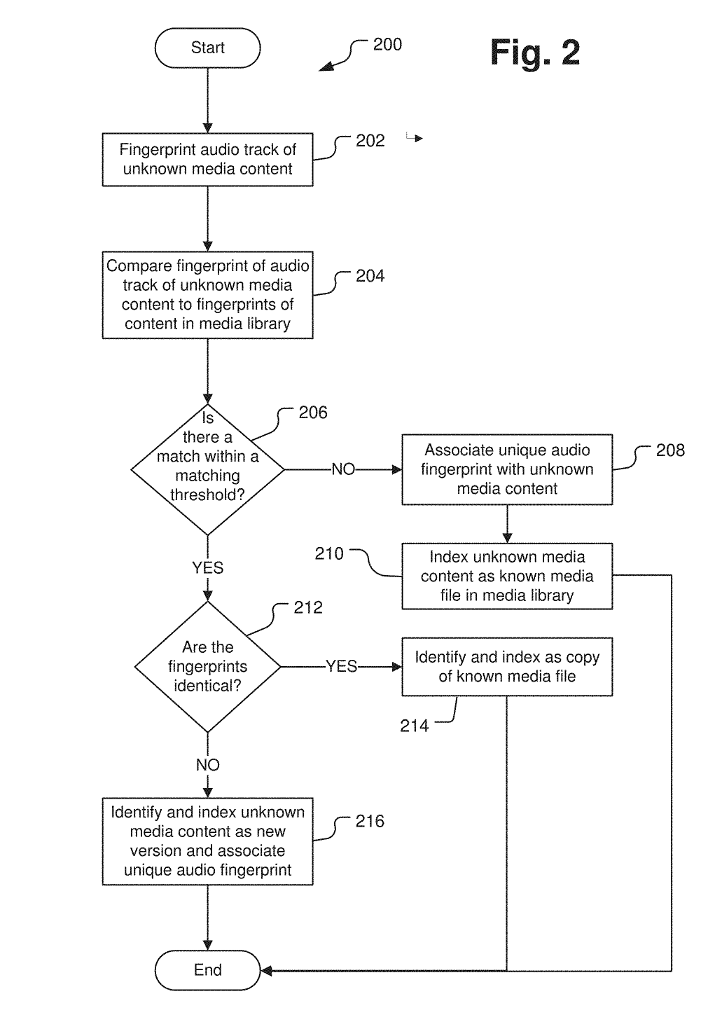

FIG. 2 is a flow chart illustrating a method of identifying and indexing unknown media content through audio fingerprint matching. The method 200 begins with perceptual hashing of an audio track of unknown media content to obtain an audio fingerprint at operation 202. It is contemplated that the audio perceptual hashing method used in this operation is the same as the methods previously described.

After operation 202, the method 200 proceeds to operation 204 and the audio fingerprint of the unknown media content is compared to audio fingerprints of content stored in a media library.

After operation 202, the method 200 proceeds to operation 206 and it is determined whether there is a match within a matching threshold between the audio fingerprint of the unknown media content and at least one audio fingerprint of the content stored in the media library.

If there is no match or the match is not within a matching threshold, the method 200 proceeds to operation 208 and the unique audio fingerprint is associated with the unknown media content. After operation 208, the method 200 proceeds to operation 210 and the unknown media content is indexed as a known media file in the media library. The previously unknown media content is now a known media file based on its unique audio fingerprint, which provides the file with a unique identifier allowing the file to be easily retrieved.

If there is a match within a matching threshold, the method 200 proceeds to operation 212 and it is determined whether the audio fingerprint of the unknown media content is identical to at least one audio fingerprint of the content stored in the media library. If there is an identical match, the method 200 proceeds to operation 214 and the unknown media file is identified and indexed as a copy of the known media file with the identical audio fingerprint. If there is no identical match, the method 200 proceeds to operation 216 and the unknown media content is identified and indexed as a new version of the known media file or files that matched within the matching threshold. The unique audio fingerprint is associated with the new version of the existing media file or files.

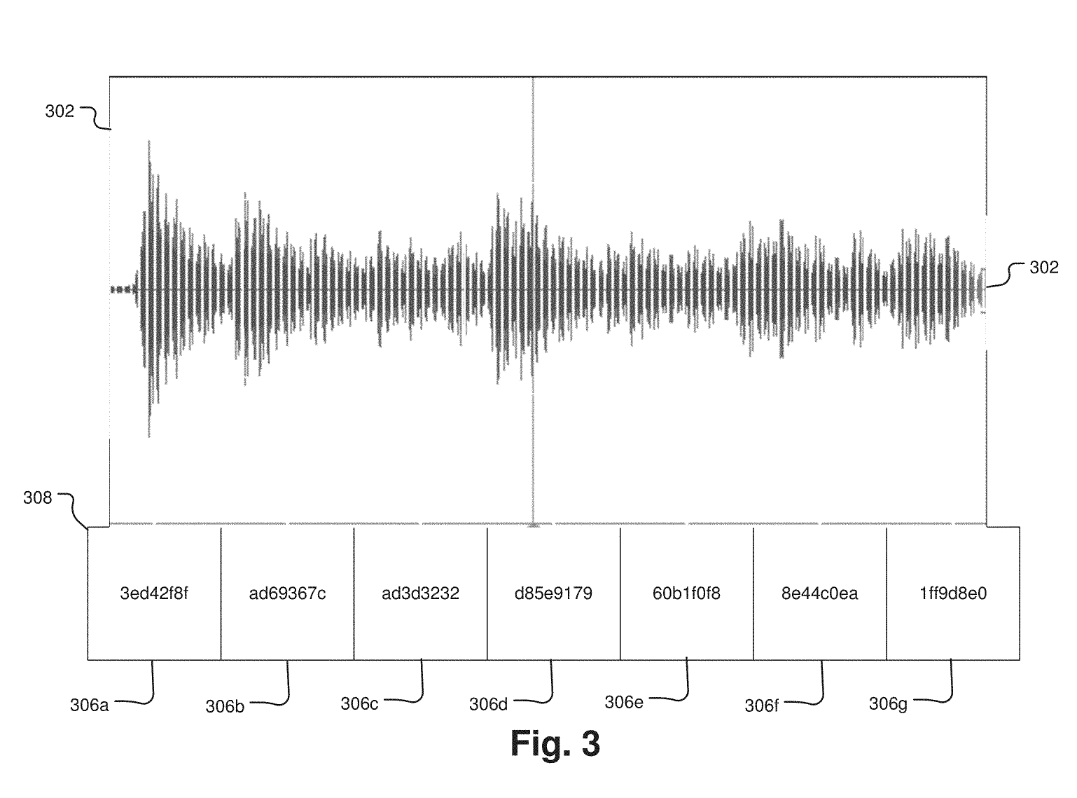

FIG. 3 is a schematic diagram illustrating a method of fingerprinting an audio track. FIG. 3 shows a sample segment of an audio track 302 that may be used to obtain an audio fingerprint 308. The audio track 302 is broken into different sampling segments or frames 304 for perceptual hashing. While seven sampling frames 304 are depicted in FIG. 3, numerous sampling frames of various sizes are contemplated. Every sampling frame 304 comes into contact with an adjacent sampling frame, such that perceptual hashing is performed along the entire length of the audio track 302. It is also contemplated that adjacent sampling frames may overlap, such that adjacent sampling frames share a portion of the audio track 302. Each sampling frame 304 provides a unique hash value 306a-g. In the example depicted in FIG. 3, each frame produces a hash value 306a-g that is a string of eight numbers and letters. For example, hash value 306a produced by the first frame 304 is represented by 3ed42f8f, hash value 306b produced by the second frame 304 is represented by ad69367c, hash value 306c produced by the third frame 304 is represented by ad3d3232, hash value 306d produced by the fourth frame 304 is represented by d85e9179, hash value 306e produced by the fifth frame 304 is represented by 60b1f0f8, hash value 306f produced by the sixth frame 304 is represented by 8e44c0ea, and hash value 306g produced by the seventh frame 304 is represented by 1ff9d8e0. It is contemplated that any number of letters and numbers may be produced as a hash value. When the string of hash values 306a-g are taken together as a whole, they represent the audio fingerprint 308 of the audio track 302. In this example, the audio track 302 is represented by its audio fingerprint 308 3ed42f8fad69367cad3d3232d85e917960b1f0f88e44c0ea1ff9d8e0. While the example depicted in FIG. 3 uses strings of numbers and letters as hash values, any mathematical representation of data is contemplated as a hash value. As one example, the hash value may be represented as a vector.

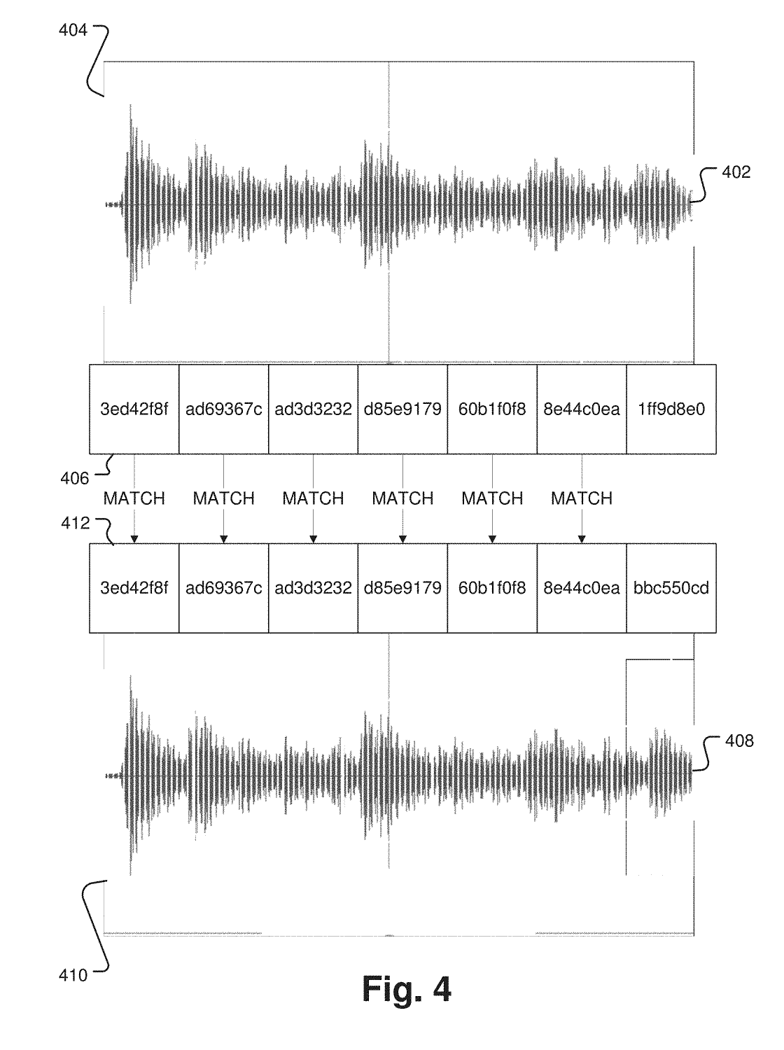

FIG. 4 is a schematic diagram illustrating a method of audio fingerprint matching. FIG. 4 shows two hashed audio tracks 402 and 408. The sampling frames 404 shown in audio track 402 were used to produce the audio fingerprint 406 of audio track 402. A similar framing structure was used on audio track 408. For example, the sampling frames for the two audio tracks 402, 408 may be generated at the same sampling rate, such that each corresponding frame on each audio track starts and ends at the same time point on each audio track. This allows similar portions of audio to be compared from each audio track. The frames 410 shown in audio track 408 were used to produce the audio fingerprint 412 of audio track 408. In the example depicted in FIG. 4, the hash values of each audio fingerprint 406, 412 may be compared during the matching process. As shown in FIG. 4, hash values 3ed42f8f at the first frame, ad69367c at the second frame, ad3d3232 at the third frame, d85e9179 at the fourth frame, 60b1f0f8 at the fifth frame, and 8e44c0ea at the sixth frame of both audio fingerprints 406, 412 match. The audio fingerprints 406, 412 therefore have matching hash values at the same position at six points along the audio fingerprint. Because six of the seven hash values match, there is an 85.7% match between the two audio tracks.

As one example, audio track 408 may represent an audio track associated with an established media file in a media library. Audio track 402 may represent an audio track associated with an unknown media file that needs to be indexed in the media library. In this example, perceptual hashing of both audio tracks 402, 408 has produced respective audio fingerprints 406, 412. In this example, FIG. 4 shows the matching process to identify and index the unknown media file associated with audio track 402 in the media library. In this example, the audio fingerprint 406 of the unknown media file has an 85.7% match with the audio fingerprint 412 of the established media file. Because this 85.7% match is within the matching threshold, the unknown media file associated with the audio fingerprint 406 may be identified as a new version of the established media file associated with the audio fingerprint 412 and indexed accordingly in the media library.

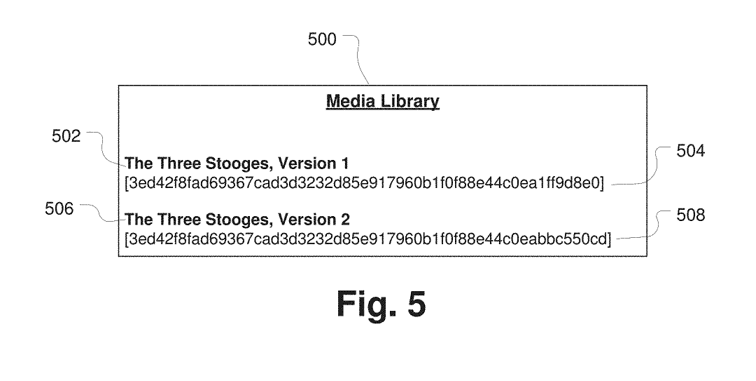

FIG. 5 is a schematic diagram illustrating an example of indexed media files in a media library based on the audio fingerprint matching of FIG. 4. FIG. 5 shows a media library 500 with two different versions 502, 506 of the same title film listed in sequence. Exemplary representations of audio fingerprints 504, 508 corresponding to the two versions 502, 506 are also shown in FIG. 5, the audio fingerprints may be hidden metadata not displayed in the media library. In this example, the audio fingerprints 504, 508 match within the matching threshold, so the media files are indexed as different versions of the same film 502, 506 in the media library 500.

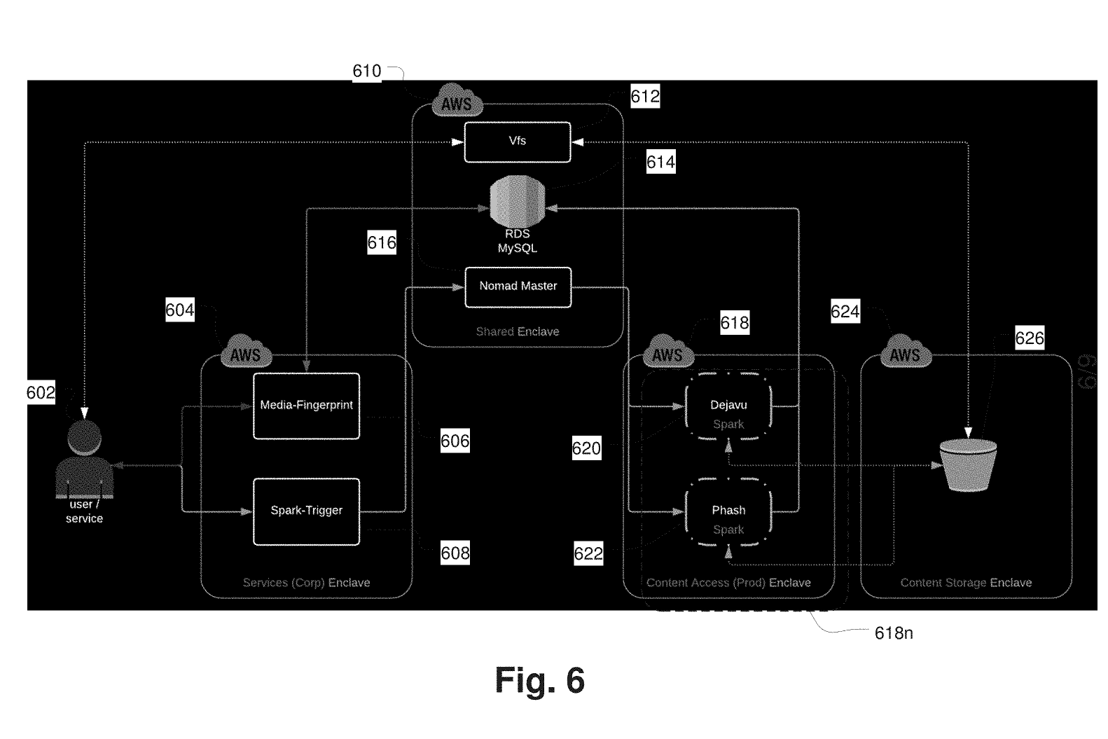

FIG. 6 depicts an exemplary implementation of a system 600 for fingerprinting and classifying video files using corresponding soundtrack information. The system 600 of FIG. 6 is implemented in an exemplary distributed cloud computing environment, for example, by using the Amazon Web Services platform. Such a platform environment allows for just-in-time access by any user and easy ability to scale processing power should a period of heavy use arise or as interest in the system 600 increases. A user 602 accesses a user interface node 604 of the system 600. The user interface node 604 may include an ingest module 606 that receives a copy of the media file to be fingerprinted and indexed. The ingest module 606 may separate the audio soundtrack from the video components of the file as only the audio soundtrack will be used for fingerprinting and identification. The audio file contains significantly less information than a video file and is thus easier to process, requiring significantly less processing resources. However, the sound signatures in the audio files are more than acceptable to use for unique identification purposes.

The ingest module may further parse the audio file into a number of smaller media files that can be processed more efficiently with a distributed data processing engine, for example, Apache Spark. In some implementations, the audio file may be parsed into a large number of sequential file segments (e.g. thousands or millions). For example, the audio file may be parsed based upon time segmentation, e.g., into one second (or other desired period) segments. The user interface node 604 may further provide the user with a Spark instantiation module 608 that implements a Spark processing environment across the distributed system 600 in order to conduct the fingerprinting process.

After ingesting the media file, the user interface node 602 may instantiate a database node 610 within the distributed processing system. The database node 610 may be outfitted with a virtual file system 612 (e.g., Microsoft Virtual File System; see https://github.com/Microsoft/VFSForGit), a relational database service 614 (e.g., Amazon RDS providing a MySQL database), and a data processing scheduler 616 (e.g., Amazon Nomad AWS). The media file provided by the user can be uploaded into the distributed system 600 by the virtual file server and stored in a library or repository 626 of complete media files in a separate storage node 624 within the distributed system 600. In other implementations, the relational database may not be used for storage of the original media file, but rather only the fingerprints and identification information used by the relational database service 614 to identify known media files. The virtual file system allows the user 602 and the elements of the distributed data processing engine access to the fingerprints and identification information stored in the repository. The relational database service 614 receives information about the media file and its segmentation scheme from the ingest module 606. The data processing scheduler 616 cooperates with the relational database service 614 to farm out and track segments of the parsed audio file for fingerprinting and recognizing.

The relational database service 616 may instantiate a plurality of additional processing nodes 618n within the distributed system to distribute the segmented media data across a number of processing nodes 618n to distribute the computation burden across the processing nodes 618n. The relational database service 616 manages the activities of the processing nodes 618n and recognizes when tasks are complete at each processing node 618 in order to serve another processing task on a different data set. Each processing node 618 may establish a number of processing engines, for example, a fingerprinting and recognition engine 620 (e.g., dejavu; see https://github.com/worldveil/dejavu) and a perceptual hash engine 622 (e.g., pHash; see http://www.phash.org/). As described further below, the fingerprinting engine 620 may be used to calculate and ascribe perceptual hash fingerprints to the audio file segments and further provide fine matching recognition of audio fingerprints of audio associated with an unknown media file. The perceptual hash engine 622 may be used to provide an initial comparison of the unknown file fingerprints with the known file fingerprints accessed through the relational database 614. In this way, perceptual hash engine 622 takes a first cut and finds fingerprints that are “close,” reducing the processing burden on the fingerprinting engine 620. The fingerprinting engine 620 makes the final comparison for recognition of a match as its algorithms are specifically designed to determine unique matches between audio fingerprints.

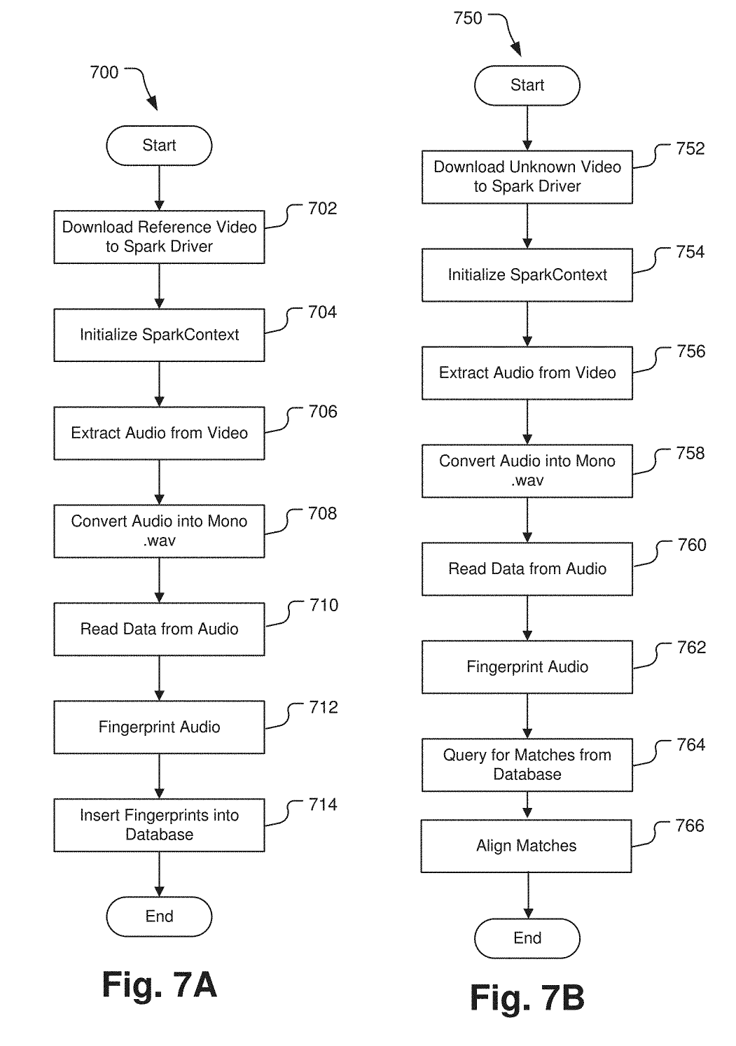

FIG. 7A depicts an exemplary workflow 700 for fingerprinting a media file using the distributed system of FIG. 6. Initially in step 702, the reference video is downloaded from the repository into the ingest module 606 on the user interface node 604 and the instantiation module 608 (Spark driver) actuates as indicated in step 704 (i.e., SparkContext initializes). The ingest module 606 extracts the audio track from the video file as indicated in step 706 and converts the audio file into a mono .wav file format as indicated in step 708 before it is stored in the repository 626. The audio data is then read from the repository 626 into the Dejavu fingerprinting module 620 on the processing nodes 618n as indicated in step 710. The audio files (or segments thereof) are fingerprinted as indicated in step 712 and the fingerprints associated with each audio file are logged into the database service 614 as indicated in step 714. In this exemplary embodiment, steps 712 and 714 are performed by Spark executors. The processing time for any particular audio file can be shortened in such a distributed processing system 600 by increasing the number of spark executors.

FIG. 7A depicts an exemplary workflow 700 for recognizing and unknown media file using the distributed system of FIG. 6. Initially in step 752, the reference video is downloaded from the repository into the ingest module 606 on the user interface node 604 and the instantiation module 608 (Spark driver) actuates as indicated in step 754 (i.e., SparkContext initializes). The ingest module 606 extracts or separates the audio track from the video in the unknown media file as indicated in step 756 and converts the audio file into a mono .wav file format as indicated in step 758 before it is stored in the repository 626. The audio data of the unknown media file is then read from the repository 626 into the Dejavu fingerprinting module 620 on the processing nodes 618n as indicated in step 760. The audio files (or segments thereof) are fingerprinted as indicated in step 762. As an initial step, the database 614 is queried for matches by the pHash module 622 in order to reduce the load on the fingerprinting module 620 and quickly identify close fingerprints of known media files in the repository 626. Any fingerprint that the pHash module 622 identifies as a close match is passed to the fingerprinting module 620 for final alignment and matching if an identical media file is indeed in the library as indicated in step 766. As noted elsewhere herein, if an exact match cannot be found, the process will note a match confidence and indicate whether the unknown media file is likely a new version of a media file already in the repository 626 or whether the unknown media file is likely content that is not already in the repository 626. Again in this exemplary embodiment, steps 762, 764, and 766 are performed by Spark executors. The processing time for any particular audio file can be shortened in such a distributed processing system 600 by increasing the number of spark executors.

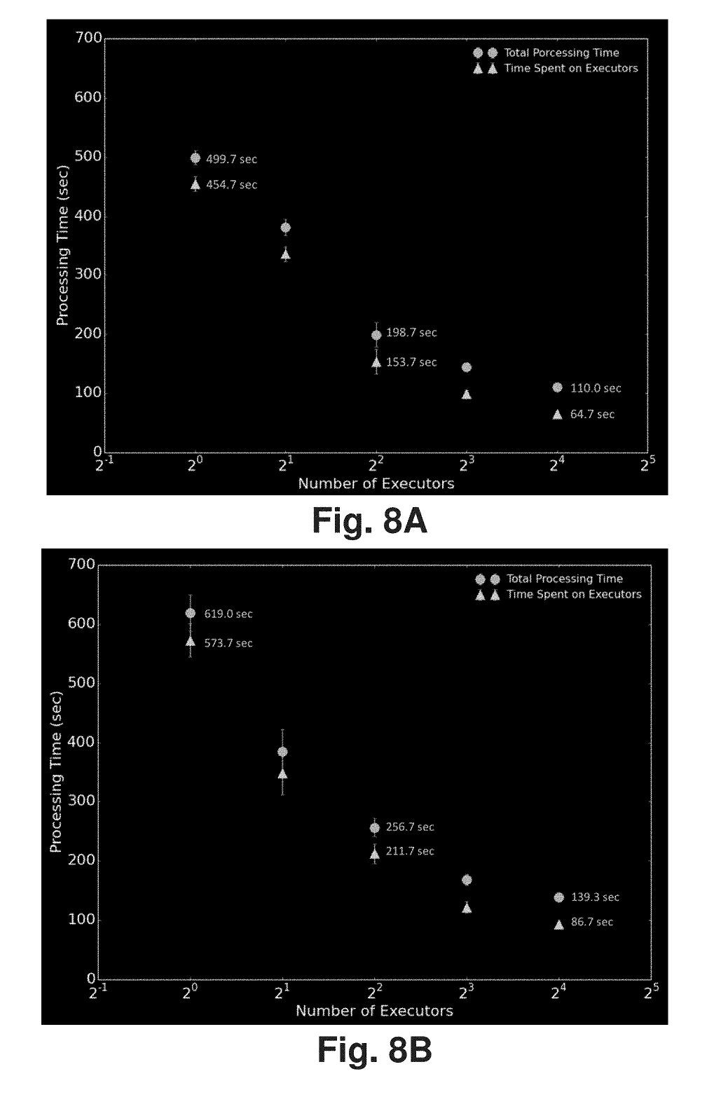

In one experiment, a two hour mp4 movie file, was used to benchmark both fingerprinting speed and unknown media recognition speed using the system of FIG. 6. The video file was chunked into 120 segments to take advantage of Spark resources. Performance metrics indicate improvements in speed in the fingerprinting 712 and insertion 714 steps in FIG. 7A and in the fingerprinting 762, querying 764, and alignment 766 steps in FIG. 7B as the number of Spark executors increases. FIG. 8A depicts a plot of the total processing time and time spent on spark executors for fingerprinting with respect to the number of executors used to implement the dejavu algorithm in a Spark processing environment. FIG. 8B depicts a plot of the total processing time and time spent on spark executors with respect to the number of executors used for identifying an unknown media file by audio fingerprint comparison, again using the dejavu algorithm in a Spark processing environment. For both fingerprinting and recognizing, the total processing time and time spent on Spark executors were significantly decreased as the number of executors increased from 1 to 16, indicating Spark did improve the performance of dejavu audio fingerprinting and unknown file matching and recognition.

The total processing time includes time for initializing SparkContext, downloading video onto the Spark driver, extracting audio and converting thea usio soundtrack into mono .wav format, reading data from the .wav file, chunking audio data into multiple segments, and time spent on executors. It took ˜31 seconds to initialize SparkContext. The time for segmenting the audio file is negligible (˜0.000003 sec) and is unrelated to the number of segments or the number of executors. It was found that the time spent on executors is the only part of the process that can be improved by using Spark. For fingerprinting, time spent on executors includes fingerprint calculation and fingerprint insertion into the database. A significant processing time reduction from 454.7 seconds to 64.7 seconds occurred as the number of executors increased from 1 to 16.

For dejavu recognizing, the time spent on executors includes time spent on fingerprinting, querying matches from the database, and aligning matches. The recognizing process also shows a dramatic reduction from 573.7 seconds to 86.7 seconds as the number of executors increased from 1 to 16. The time for recognizing is longer than fingerprinting the same audio file for a video with the same number of executors. This time increase is attributed to the fact that it takes a longer time to query for matches from the database for a video with large number of fingerprints. In general, there are 8-10 million fingerprints for a 2-hour-video.

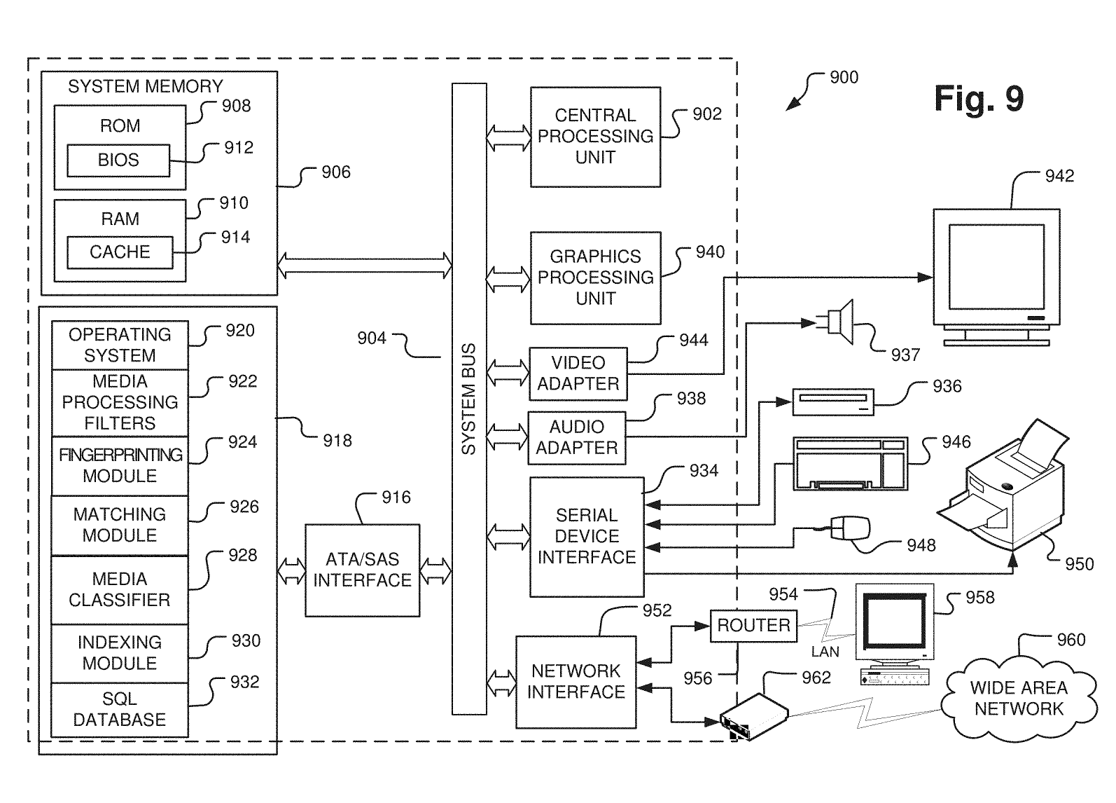

An exemplary computer-implemented media processing and classifying system 900 for implementing the fingerprinting and indexing processes above is depicted in FIG. 9. The media classifying system 900 may be embodied in a specifically configured, high-performance computing system including a cluster of computing devices in order to provide a desired level of computing power and processing speed. Alternatively, the process described herein could be implemented on a computer server, a mainframe computer, a distributed computer, a personal computer (PC), a workstation connected to a central computer or server, a notebook or portable computer, a tablet PC, a smart phone device, an Internet appliance, or other computer devices, or combinations thereof, with internal processing and memory components as well as interface components for connection with external input, output, storage, network, and other types of peripheral devices. Internal components of the media classifying system 600 in FIG. 9 are shown within the dashed line and external components are shown outside of the dashed line. Components that may be internal or external are shown straddling the dashed line.

In any embodiment or component of the system described herein, the media classifying system 900 includes one or more processors 902 and a system memory 906 connected by a system bus 904 that also operatively couples various system components. There may be one or more processors 902, e.g., a single central processing unit (CPU), or a plurality of processing units, commonly referred to as a parallel processing environment (for example, a dual-core, quad-core, or other multi-core processing device). In addition to the CPU, the image classifying system 600 may also include one or more graphics processing units (GPU) 640. A GPU 640 is specifically designed for rendering video and graphics for output on a monitor. A GPU 640 may also be helpful for handling video processing functions even without outputting an image to a monitor. By using separate processors for system and graphics processing, computers are able to handle video and graphic-intensive applications more efficiently. As noted, the system may link a number of processors together from different machines in a distributed fashion in order to provide the necessary processing power or data storage capacity and access.

The system bus 904 may be any of several types of bus structures including a memory bus or memory controller, a peripheral bus, a switched-fabric, point-to-point connection, and a local bus using any of a variety of bus architectures. The system memory 906 includes read only memory (ROM) 908 and random access memory (RAM) 910. A basic input/output system (BIOS) 912, containing the basic routines that help to transfer information between elements within the computer system 900, such as during start-up, is stored in ROM 908. A cache 914 may be set aside in RAM 910 to provide a high speed memory store for frequently accessed data.

A data storage device 918 for nonvolatile storage of applications, files, and data may be connected with the system bus 904 via a device attachment interface 916, e.g., a Small Computer System Interface (SCSI), a Serial Attached SCSI (SAS) interface, or a Serial AT Attachment (SATA) interface, to provide read and write access to the data storage device 918 initiated by other components or applications within the image classifying system 900. The data storage device 918 may be in the form of a hard disk drive or a solid state memory drive or any other memory system. A number of program modules and other data may be stored on the data storage device 918, including an operating system 920, one or more application programs, and data files. In an exemplary implementation, the data storage device 918 may store various media processing filters 922, a fingerprinting module 924, a matching module 626, a media classifier 928, an indexing module 930, as well as the media files being processed and any other programs, functions, filters, and algorithms necessary to implement the media classifying procedures described herein. The data storage device 918 may also host a database 932 (e.g., a SQL database) for storage of video frame time stamps, audio track framing parameters, audio track fingerprints, hashing algorithms, media meta data, and other relational data necessary to perform the media processing and classification procedures described herein. Note that the data storage device 918 may be either an internal component or an external component of the computer system 900 as indicated by the hard disk drive 918 straddling the dashed line in FIG. 6.

In some configurations, the image classifying system 900 may include both an internal data storage device 918 and one or more external data storage devices 936, for example, a CD-ROM/DVD drive, a hard disk drive, a solid state memory drive, a magnetic disk drive, a tape storage system, and/or other storage system or devices. The external storage devices 936 may be connected with the system bus 904 via a serial device interface 934, for example, a universal serial bus (USB) interface, a SCSI interface, a SAS interface, a SATA interface, or other wired or wireless connection (e.g., Ethernet, Bluetooth, 802.11, etc.) to provide read and write access to the external storage devices 936 initiated by other components or applications within the image classifying system 900. The external storage device 936 may accept associated computer-readable media to provide input, output, and nonvolatile storage of computer-readable instructions, data structures, program modules, and other data for the media classifying system 900.

A display device 942, e.g., a monitor, a television, or a projector, or other type of presentation device may also be connected to the system bus 904 via an interface, such as a video adapter 940 or video card. Similarly, audio devices, for example, external speakers, headphones, or a microphone (not shown), may be connected to the system bus 904 through an audio card or other audio interface 638 for presenting audio associated with the media files.

In addition to the display device 642 and audio device 647, the media classifying system 900 may include other peripheral input and output devices, which are often connected to the processor 902 and memory 906 through the serial device interface 944 that is coupled to the system bus 906. Input and output devices may also or alternately be connected with the system bus 904 by other interfaces, for example, a universal serial bus (USB), an IEEE 1494 interface (“Firewire”), a parallel port, or a game port. A user may enter commands and information into the media classifying system 900 through various input devices including, for example, a keyboard 946 and pointing device 948, for example, a computer mouse. Other input devices (not shown) may include, for example, a joystick, a game pad, a tablet, a touch screen device, a satellite dish, a scanner, a facsimile machine, a microphone, a digital camera, and a digital video camera.

Output devices may include a printer 950. Other output devices (not shown) may include, for example, a plotter, a photocopier, a photo printer, a facsimile machine, and a printing press. In some implementations, several of these input and output devices may be combined into single devices, for example, a printer/scanner/fax/photocopier. It should also be appreciated that other types of computer-readable media and associated drives for storing data, for example, magnetic cassettes or flash memory drives, may be accessed by the computer system 900 via the serial port interface 944 (e.g., USB) or similar port interface. In some implementations, an audio device such as a loudspeaker may be connected via the serial device interface 634 rather than through a separate audio interface.

The media classifying system 900 may operate in a networked environment using logical connections through a network interface 952 coupled with the system bus 904 to communicate with one or more remote devices. The logical connections depicted in FIG. 9 include a local-area network (LAN) 954 and a wide-area network (WAN) 960. Such networking environments are commonplace in home networks, office networks, enterprise-wide computer networks, and intranets. These logical connections may be achieved by a communication device coupled to or integral with the media classifying system 900. As depicted in FIG. 9, the LAN 954 may use a router 956 or hub, either wired or wireless, internal or external, to connect with remote devices, e.g., a remote computer 958, similarly connected on the LAN 954. The remote computer 958 may be another personal computer, a server, a client, a peer device, or other common network node, and typically includes many or all of the elements described above relative to the computer system 900.

To connect with a WAN 960, the media classifying system 900 typically includes a modem 962 for establishing communications over the WAN 960. Typically the WAN 960 may be the Internet. However, in some instances the WAN 960 may be a large private network spread among multiple locations, or a virtual private network (VPN). The modem 962 may be a telephone modem, a high speed modem (e.g., a digital subscriber line (DSL) modem), a cable modem, or similar type of communications device. The modem 962, which may be internal or external, is connected to the system bus 918 via the network interface 952. In alternate embodiments the modem 962 may be connected via the serial port interface 944. It should be appreciated that the network connections shown are exemplary and other means of and communications devices for establishing a network communications link between the computer system and other devices or networks may be used.

The technology described herein may be implemented as logical operations and/or modules in one or more systems. The logical operations may be implemented as a sequence of processor-implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The above specification, examples and data provide a complete description of the structure and use of exemplary embodiments of the invention as defined in the claims. Although various embodiments of the claimed invention have been described above with a certain degree of particularity, or with reference to one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A computer-implemented video classification system comprising
a storage device configured to ingest and store one or more video files thereon, wherein the one or more video files comprise one or more respective audio tracks;
one or more processors configured with instructions to
perform a perceptual hash algorithm on each of the one or more audio tracks;
generate one or more audio fingerprints for the respective one or more audio tracks;
associate the one or more audio fingerprints with the respective one or more video files; and
index the one or more video files based upon the one or more respective audio fingerprints.

2. The computer-implemented video classification system of claim 1, wherein performing the perceptual hash algorithm and generating one or more audio fingerprints comprises
dividing the one or more audio tracks into a plurality of sampling segments along the entire length of each of the one or more audio tracks, wherein the plurality of sampling segments are generated at a sampling rate that is the same for each of the one or more audio tracks;
performing the perceptual hash algorithm on each of the plurality of sampling segments to produce a hash code for each of the plurality of sampling segments; and
stringing together the hash code of each of the plurality of sampling segments on an audio track for the one or more audio tracks to produce the one or more audio fingerprints.

3. The computer-implemented video classification system of claim 1, wherein the one or more processors are further configured with instructions to
compare two or more audio fingerprints to determine a match level between the two or more audio fingerprints;
determine whether the match level is within a matching threshold;
if the one or more processors determines the match level is within the matching threshold, identify the associated one or more video files as one or more new versions; and
if the one or more processors determines the match level is not within the matching threshold, identify the associated one or more video files as one or more new video files or copies.

4. The computer-implemented video classification system of claim 3, wherein the matching threshold is within a range of less than about 95% and greater than about 50%.

5. The computer-implemented video classification system of claim 3, wherein the one or more video files are identified as one or more new video files when the match level is equal to less than about 50%.

6. The computer-implemented video classification system of claim 3, wherein the one or more video files are identified as one or more copies when the match level is equal to greater than about 95%.

7. The computer-implemented video classification system of claim 3, wherein the one or more video files are identified as one or more new versions when the matching level is about 85%.

8. The computer-implemented video classification system of claim 1, wherein the one or more processors are further configured with instructions to store the one or more audio fingerprints associated with each of the one or more video files in a database on the storage device.

9. A method implemented in a computer system for identifying video files in a media library, wherein one or more processors in the computer system is particularly configured to perform a number of processing steps comprising
performing an audio perceptual hash of a plurality of audio tracks associated with a plurality of video files in a media library to produce a plurality of audio fingerprints;
associating each audio fingerprint with a respective video file in the media library;
creating a media library of identifiable video files based upon the respective audio fingerprint;
comparing the plurality of audio fingerprints to determine whether any of the plurality of audio fingerprints match within a threshold matching rate; and
if there is a match between two or more audio fingerprints within the threshold matching rate, identifying the respective video files associated with the two or more audio fingerprints as different versions of the same video file.

10. The method of claim 10, wherein the threshold match level is within a range of less than about 95% and greater than about 50%.

11. A non-transitory computer readable storage medium containing instructions for instantiating a special purpose computer to index an unknown video file in a media library of known video files, wherein the instructions implement a computer process comprising the steps of
ingesting and storing one or more known video files on a storage device within a computer system, wherein the one or more known video files are associated with one or more hashed audio tracks with one or more associated audio fingerprints;
receiving one or more unknown video files;
performing audio perceptual hashing of one or more audio tracks associated with the one or more unknown video files to produce one or more associated audio fingerprints of the one or more unknown video files;
comparing the one or more audio fingerprints of the one or more unknown video files to the one or more audio fingerprints of the one or more known video files; and
determining a match level for each of the one or more audio fingerprints of the one or more unknown video files to each of the one or more audio fingerprints of the one or more known video files; and
identifying and indexing the one or more unknown video files based upon the match level to each known video file.

12. The non-transitory computer readable storage medium of claim 12, wherein the identifying and indexing step further comprises determining whether the match level is less than about 50%, is within a threshold matching range of greater than about 50% and less than about 95%, or is greater than about 95%.

13. The non-transitory computer readable storage medium of claim 13, wherein
if the match level is 0%, determining that the one or more unknown video files are not associated with one or more known video files and identifying and indexing the one or more unknown video files as new video files;
if the match level is within the threshold matching range of greater than about 50% to less than about 95%, determining the one or more unknown video files are associated with one or more known video files and identifying and indexing the one or more unknown video files as new versions of the one or more known video files; and
if the match level is greater than about 95%, determining the one or more unknown video files are associated with the one or more known video files and identifying and indexing the one or more unknown video files as copies of the one or more known video files.
